(19) United States
(12) Patent Application Publication
(10) Pub. No.: US 2010/0057481 A1
(43) Pub. Date: Mar. 4, 2010

(54) REAL-TIME GEO-LOCATION BASED CONTACT SERVICE SYSTEM

(76) Inventors: Gene Fein, Malibu, CA (US); Edward Merritt, Lenox, MA (US)

Correspondence Address: FOLEY & LARDNER LLP, 150 EAST GILMAN STREET, P.O. BOX 1497, MADISON, WI, 53701-1497, US

(21) Appl. No.: 12/200,339

(22) Filed: Aug. 28, 2008

(51) Int. Cl. G06Q 99/00; G01S 1/00

(52) U.S. Cl. 705/1; 342/357.06

(57) ABSTRACT

A method of providing a notification to a user of a geographic proximity to another user is provided. The method includes receiving user profile information for a first user and user location information for a plurality of users from a second device at a first device. Contacts are identified using the received user profile information. A current geographic location of the identified contacts and the first user is identified based on the received user location information. The plurality of users includes the identified contacts and the first user. A distance between a contact of the identified contacts and the first user is determined. If the determined distance is within a notification distance, a notification message is created, and the notification message is sent to the second device from the first device. The notification message includes an identifier of the contact and the first user and an indicator of the current geographic location of the contact.

### BACKGROUND

Dating or personal introduction services match potential mates using demographic profiles, interviews, associated preferences, etc. Such services support communication between potential dating matches prior to and after initial introduction, for example using e-mail, instant messaging, a phone, etc. These services can include communications held within the dating service user interface or external communications to the dating service user interface. The services are easy to join and range from free services to highly specialized and expensive services. Conventional models of online introduction include the registration of new users after a period of time in which the user may utilize some aspects of the system to determine their interest in such a system. Users can then register to have full access to the system enabling contact with potential matches, as well as the dissemination of user profiles and photos into the system.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 depicts a block diagram of a geo-location contact service system in accordance with an illustrative embodiment.

FIG. 2 depicts a block diagram of a user computing device of the geo-location contact service system of FIG. 1 in accordance with an illustrative embodiment.

FIG. 3 depicts a block diagram of a middleware system of the geo-location contact service system of FIG. 1 in accordance with an illustrative embodiment.

FIG. 4 depicts a block diagram of a cloud computing system of the geo-location contact service system of FIG. 1 in accordance with an illustrative embodiment.

FIG. 5 depicts a flow diagram illustrating operations performed by the cloud computing system of FIG. 4 in accordance with an Illustrative embodiment.

FIG. 6 depicts a flow diagram illustrating operations performed by the user computing device of FIG. 2 in accordance with an Illustrative embodiment.

FIG. 7 depicts a flow diagram illustrating operations performed by the middleware system of FIG. 3 in accordance with an Illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

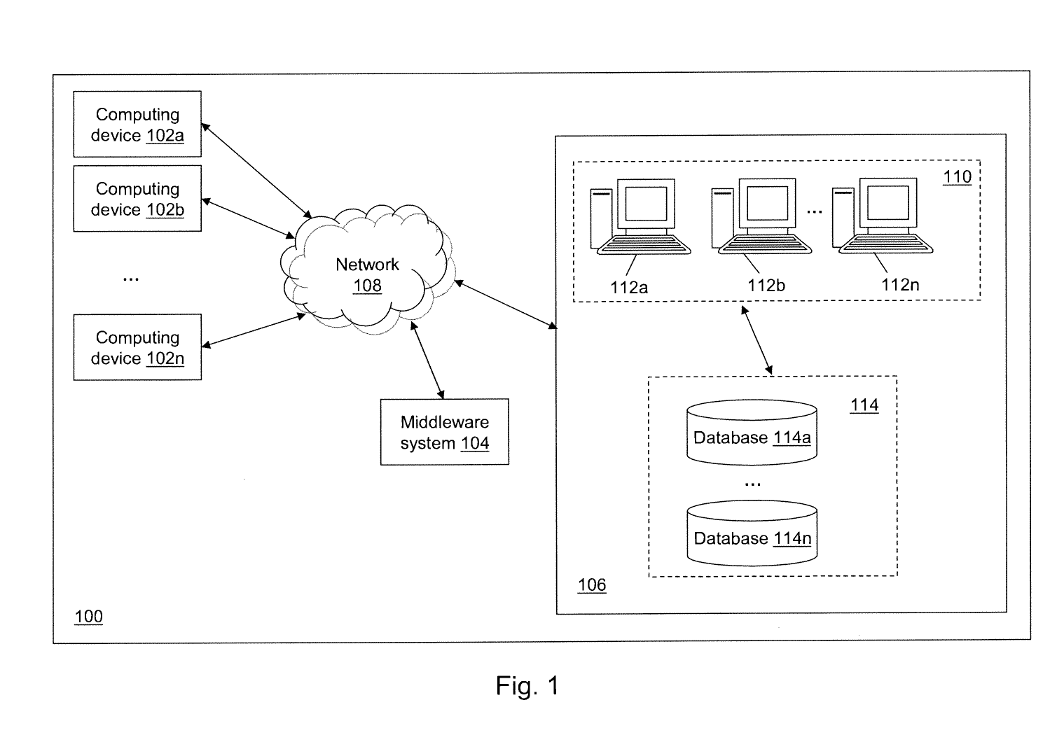

Illustrative systems, methods, devices, etc. are described for geo-location contact service systems using user provided information and current user location information for a plurality of users. With reference to FIG. 1, a block diagram of a geo-location contact service system 100 is shown in accordance with an illustrative embodiment. Geo-location contact service system 100 can include one or more user computing devices 102a, 102b, . . . , 102n, a middleware system 104, and a cloud computing system 106. The one or more user computing devices 102a, 102b, . . . , 102n may be a computer of any form factor including a laptop, a desktop, a server, an integrated messaging device, a personal digital assistant, a cellular telephone, an iPod™, etc. The one or more user computing devices 102a, 102b, . . . , 102n may be associated with the same and/or different users. The devices associated with the one or more user computing devices 102a, 102b, . . . , 102n, middleware system 104, and cloud computing system 106 may communicate using a network 108. Network 108 may include one or more type of network including a cellular network, a peer-to-peer network, the Internet, a local area network, a wide area network, a Wi-Fi network, a Bluetooth™ network, etc.

Cloud computing system 106 can include one or more servers 110 and one or more databases 114. A cloud computing system refers to one or more computational resources accessible over a network to provide users with on-demand computing services. The one or more servers 110 can include one or more computing devices 112a, 112b, . . . , 112n which may be computers of any form factor. The one or more databases 114 can include a first database 114a, . . . , and an nth database 114n. The one or more databases 114 can be housed on one or more of the one or more servers 110 or may be housed on separate computing devices accessible by the one or more servers 110 directly through wired or wireless connection or through network 108. The one or more databases 114 may be organized into tiers and may be developed using a variety of database technologies without limitation. The components of cloud computing system 106 may be implemented in a single computing device or a plurality of computing devices in a single location, in a single facility, and/or may be remote from one another.

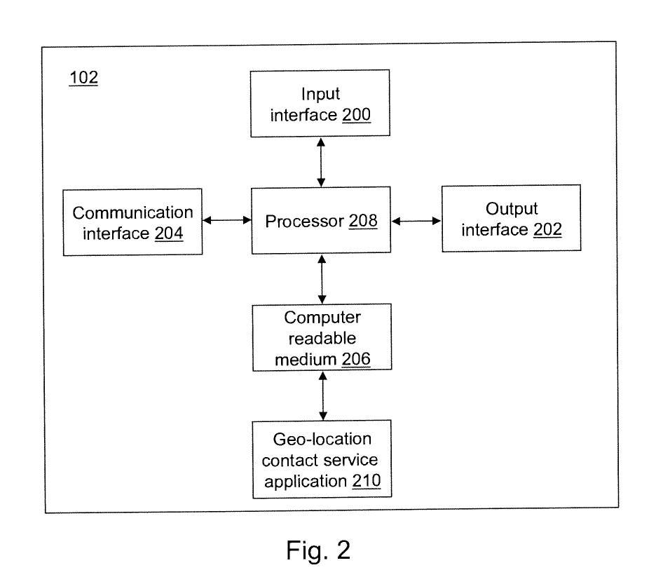

With reference to FIG. 2, a block diagram of a user computing device 102 of geo-location contact service system 100 is shown in accordance with an illustrative embodiment. User computing device 102 can include an input interface 200, an output interface 202, a communication interface 204, a computer-readable medium 206, a processor 208, and a geo-location contact service application 210. Different and additional components may be incorporated into user computing device 102 without limitation. Geo-location contact service application 210 provides a graphical user interface with user selectable and controllable functionality. Geo-location contact service 210 may include a browser application and/or other user interface based application that interacts with middleware system 104 to automatically, or under control of the user, monitor a geographic location of a user and notify the user if one or more other users are in close proximity to the user in order to arrange a meeting.

Input interface 200 provides an interface for receiving information from the user for entry into user computing device 102 as known to those skilled in the art. Input interface 200 may interface with various input technologies including, but not limited to, a keyboard, a pen and touch screen, a mouse, a track ball, a touch screen, a keypad, one or more buttons, etc. to allow the user to enter information into user computing device 102 or to make selections presented in a user interface displayed using a display under control of geo-location contact service application 210. Input interface 104 may provide both an input and an output interface. For example, a touch screen both allows user input and presents output to the user. User computing device 102 may have one or more input interfaces that use the same or a different interface technology.

Output interface 202 provides an interface for outputting information for review by a user of user computing device 102. For example, output interface 202 may include an interface to a display, a printer, a speaker, etc. The display may be any of a variety of displays including, but not limited to, a thin film transistor display, a light emitting diode display, a liquid crystal display, etc. The printer may be any of a variety of printers including, but not limited to, an ink jet printer, a laser printer, etc. User computing device 102 may have one or more output interfaces that use the same or a different interface technology.

Communication interface 204 provides an interface for receiving and transmitting data between devices using various protocols, transmission technologies, and media. The communication interface may support communication using various transmission media that may be wired or wireless. User computing device 102 may have one or more communication interfaces that use the same or different protocols, transmission technologies, and media.

Computer-readable medium 206 is an electronic holding place or storage for information so that the information can be accessed by processor 208. Computer-readable medium 206 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disk (CD), digital versatile disk (DVD), . . . ), smart cards, flash memory devices, etc. User computing device 102 may have one or more computer-readable media that use the same or a different memory media technology. User computing device 102 also may have one or more drives that support the loading of a memory media such as a CD, a DVD, a flash memory card, etc.

Processor 208 executes instructions as known to those skilled in the art. The instructions may be carried out by a special purpose computer, logic circuits, or hardware circuits. Thus, processor 208 may be implemented in hardware, firmware, software, or any combination of these methods. The term “execution” is the process of running an application or the carrying out of the operation called for by an instruction. The instructions may be written using one or more programming language, scripting language, assembly language, etc. Processor 208 executes an instruction, meaning that it performs the operations called for by that instruction. Processor 208 operably couples with input interface 200, with output interface 202, with communication interface 204, with computer-readable medium 206, and with geo-location contact service application 210 to receive, to send, and to process information. Processor 208 may retrieve a set of instructions from a permanent memory device and copy the instructions in an executable form to a temporary memory device that is generally some form of RAM. User computing device 102 may include a plurality of processors that use the same or a different processing technology.

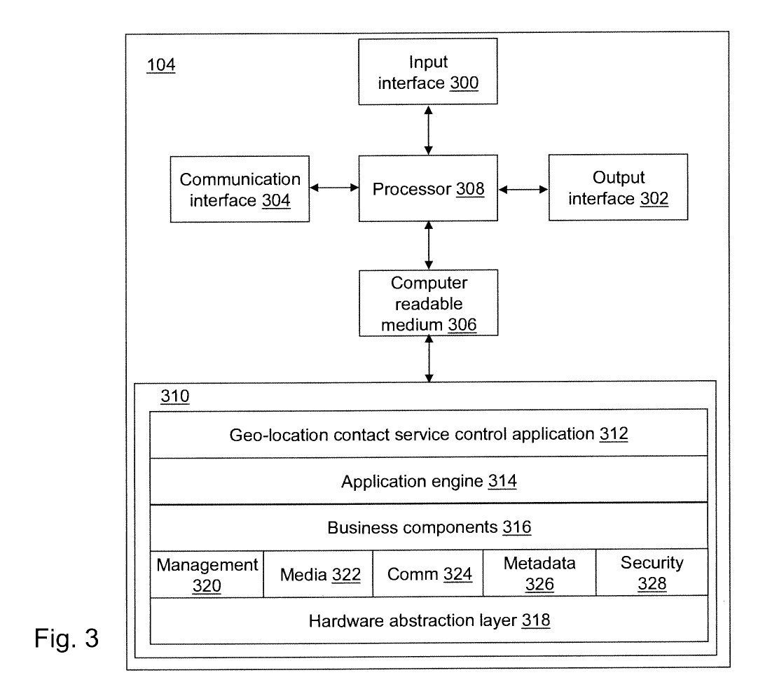

With reference to FIG. 3, a block diagram of middleware system 104 of geo-location contact service system 100 is shown in accordance with an illustrative embodiment. Middleware system 104 can include an input interface 300, an output interface 302, a communication interface 304, a computer-readable medium 306, a processor 308, and a geo-location contact service system architecture 310. Different and additional components may be incorporated into middleware system 104 without limitation. For example, middleware system 104 may include a database that is directly accessible by middleware system 104 or accessible by middleware system 104 using a network such as network 108. Middleware system 104 may further include a cache for temporarily storing information communicated to middleware system 104. Input interface 300 provides similar functionality to input interface 200. Output interface 302 provides similar functionality to output interface 202. Communication interface 304 provides similar functionality to communication interface 204. Computer-readable medium 306 provides similar functionality to computer-readable medium 206. Processor 308 provides similar functionality to processor 208.

Geo-location contact service system architecture 310 can include a geo-location contact service control application 312, an application engine 314, business components 316, and a hardware abstraction layer 318. Geo-location contact service control application 312 includes the operations associated with interfacing between cloud computing system 106 and user computing device 102 to maintain and organize user location information and to process a request for a geo-location contact. Geo-location contact service control application 312 includes functionality to support registration, sign-in, profile input, profile management, match presentation, communication with matches, location of matches, initiation, confirmation, activity lists, favorites list, meeting place lists, a “right now” meeting function for immediate location and match willingness evaluation, multimedia displays of locations, matches and recommendations, etc.

Geo-location contact service system architecture 310 may utilize load balancing servers, content servers, database servers, application servers, and registration servers. The application and registration servers facilitate the registration process for a user as well as the download of geo-location contact service application 210 and application updates. Middleware system 104 is configured to download the correct software application for the one or more user computing devices 102a, 102b, . . . , 102n based upon registration information received from the user. During the registration process the user may fill in certain fields that assist in the identification of the user's contacts. User related data is received from the one or more user computing devices 102a, 102b, . . . , 102n and formatted using the application and database servers. The load balancing servers sort user queries. Middleware system 104 sends user location data points to cloud computing system 106.

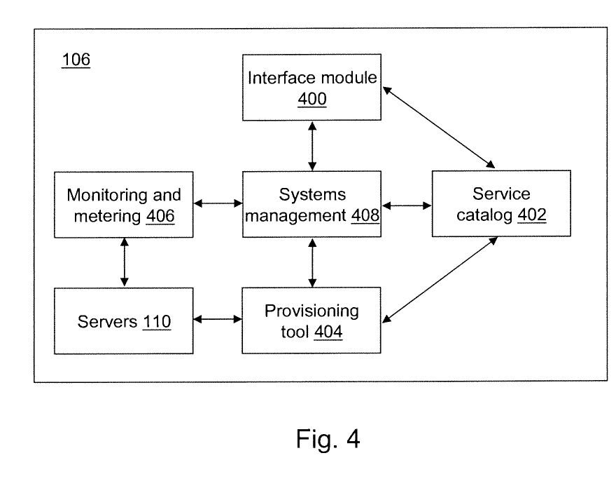

With reference to FIG. 4, a block diagram of modules associated with cloud computing system 106 of geo-location contact service system 100 is shown in accordance with an illustrative embodiment. Cloud computing system 106 can include an interface module 400, a service catalog 402, a provisioning tool 404, a monitoring and metering module 406, a system management module 408, and the one or more servers 110. Different and additional components may be incorporated into cloud computing system 106 without limitation. For example, cloud computing system 106 may further include the one or more databases 114. Middleware system 104 interacts with interface module 400 to request services. Service catalog 402 provides a list of services that middleware system 104 can request. Provisioning tool 404 allocates computational resources from the one or more servers 110 to deliver the requested service and may deploy the required images for execution at the one or more servers 110. Monitoring and metering module 406 tracks the usage of the one or more servers 110 so the resources used can be attributed to a certain user possibly for billing purposes. System management module 408 manages the one or more servers 110. The one or more servers 110 can be interconnected as if in a grid running in parallel.

Interface module 400 may be configured to allow selection of a service from service catalog 402. A request associated with a selected service may be sent to system management module 408. System management module 408 identifies an available resource(s) such as one or more of servers 110 and/or one or more of databases 114. System management module 408 calls provisioning tool 404 to allocate the identified resource(s). Provisioning tool 404 may deploy a requested stack or web application as well.

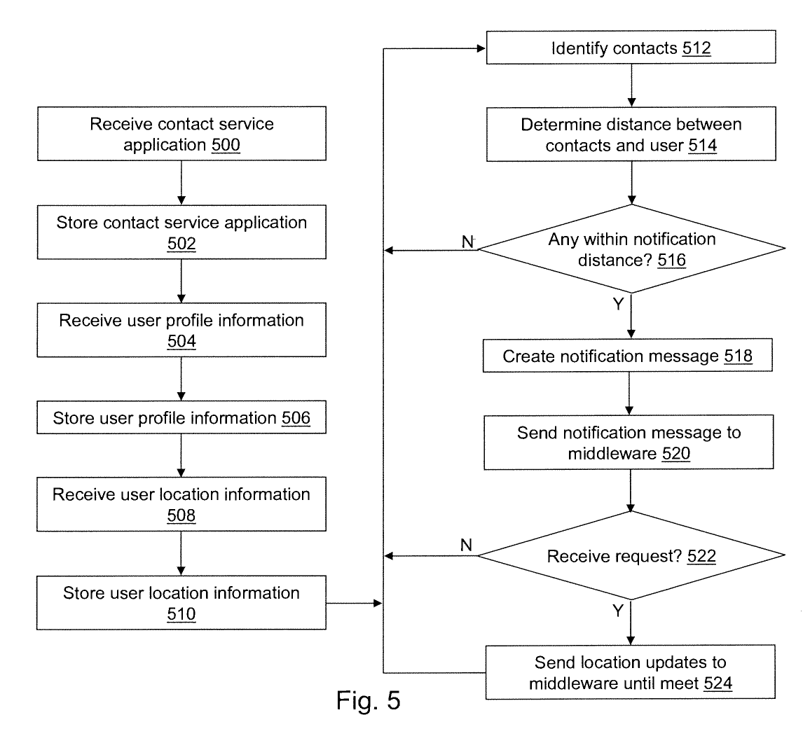

With reference to FIG. 5, illustrative operations performed by cloud computing system 106 are described. Additional, fewer, or different operations may be performed, depending on the embodiment. The order of presentation of the operations of FIG. 5 is not intended to be limiting. In an operation 500, one or more geo-location contact service applications are received. The one or more geo-location contact service applications may be in a text format, an object code format, or an executable format. The received one or more geo-location contact system applications are stored to cloud computing system 106 in an operation 502. User profile information is received in an operation 504. For example, user profile information may include home and work/vocation address, age, sex, race, sexual orientation, income, entertainment and media preferences, vacation preferences, restaurant preferences, exercise preferences, social habits, political affiliations, hobbies, likes and dislikes, personality profile, etc. In an operation 506, the user profile information is stored in cloud computing system 106. In an operation 508, user location information is received. In an operation 510, the user location information is stored in cloud computing system 106. Operations 504-510 are repeated for a plurality of users.

In an operation 512, contacts are identified from the user information. For example, the user may provide a contact list of other users of geo-location contact service system 100. As another example, a dating service application may identify possible matches from the other users of geo-location contact service system 100 to identify the contacts. In an operation 514, the current geographic location of the identified contacts and the user is determined, and a distance between the user and the identified contacts is determined. If none of the contacts are within a notification distance, processing continues at operation 512 to update the contacts and continue to monitor the distances between the identified contacts and the user. The notification distance may be defined by the user based on their convenience. Geo-location contact service system 100 also may have a default value. The default value may be related to a time period for traveling the notification distance based on available transportation methods.

If any of the contacts are within the notification distance, processing continues at operation 518 to create a notification message. The notification message may include an identifier of the contact or contacts within the notification distance. The notification message also may include an indicator of the current geographic location of the contact or contacts within the notification distance. In an operation 520, the created notification message is sent to middleware system 104. If a request is not received in an operation 522, processing continues at operation 512 to continuously update the contacts and continue to monitor the distances between the contacts and the user. If a request is received in operation 522, processing continues at operation 524. In operation 524, the locations of the user and the contact(s) identified as being within the notification distance are monitored by sending location updates to middleware system 104 until the user and the identified contact(s) meet.

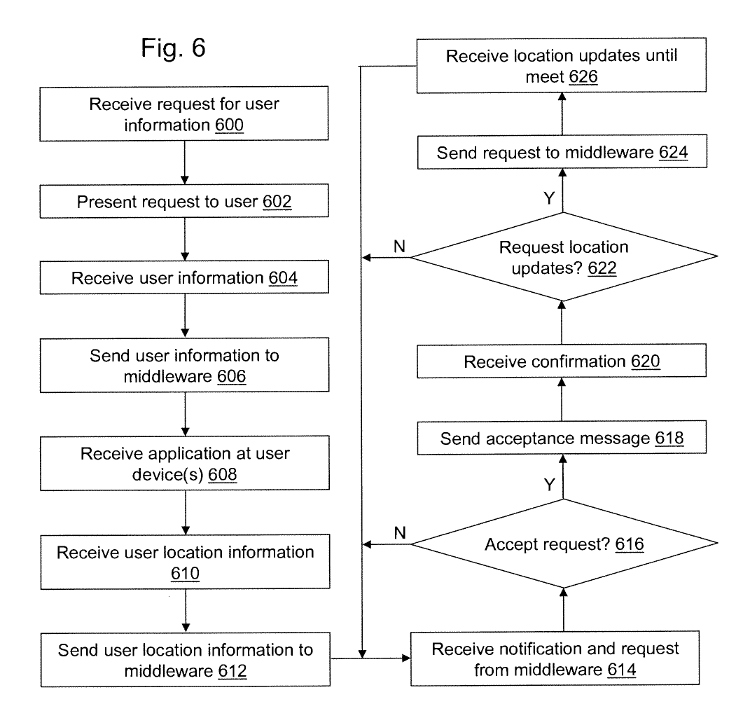

With reference to FIG. 6, illustrative operations performed by user computing device 102 are described. Additional, fewer, or different operations may be performed, depending on the embodiment. The order of presentation of the operations of FIG. 6 is not intended to be limiting. In an operation 600, a first request for a user to enter information is received. For example, the user may access a website using a browser application which causes the first request to be received at user computing device 102. In an operation 602, the request for information is presented to the user. For example, the user may be presented with a series of questions to identify the user's preferences, habits, likes, dislikes, contacts, etc. In an operation 604, the user information is received. In an operation 606, the received user information is sent to middleware system 104. In an operation 608, geo-location contact service application 210 is received and installed, if necessary, at one or more of the user's computing devices. After being received and installed, if necessary, the one or more of the user's computing devices execute geo-location contact service application 210.

In an operation 610, a geographic location of user computing device 102 is received. For example, user computing device 102 may include a global positioning system that determines the geographic location of user computing device 102 and sends the geographic location to geo-location contact service application 210. The geographic location of user computing device 102 could also be based upon a user expressly defining their position, radio frequency identification or other transponder location systems, or by IP address mapping. In an operation 612, the geographic location of user computing device 102 is sent to middleware system 104. The information may be sent under user control and/or automatically. In an operation 614, a notification and request is received from middleware system 104. The notification includes an identification of one or more other users who are within the notification distance of the user's current location. The notification may display the location of the users on a map, provide an address, etc. The request includes a request to indicate if the user would like to meet with one or more user of the one or more identified users. The request also may include proposed meeting locations that may be based on the geographic location of the user and the one or more other users and/or on the user profile information of the user. Alternatively, the user may specify a meeting location. If the user does not accept the request in an operation 616, processing continues at operation 614. If the user does accept the request in operation 616, processing continues at an operation 618. In operation 618, an acceptance message is sent to middleware system 104 identifying the other users that the user would like to meet. In an operation 620, a confirmation message is received confirming whether or not any of the identified also accepted the request.

If the user does not request location updates in an operation 622, processing continues at operation 614. If the user requests location updates in operation 622, processing continues at operation 624. In operation 624, a location update request is sent to middleware system 104. In an operation 626, the location updates are received from middleware system 104 until the users meet. For example, the location of the users may be displayed on a map to indicate their relative positions and may indicate an estimated arrival time for each user.

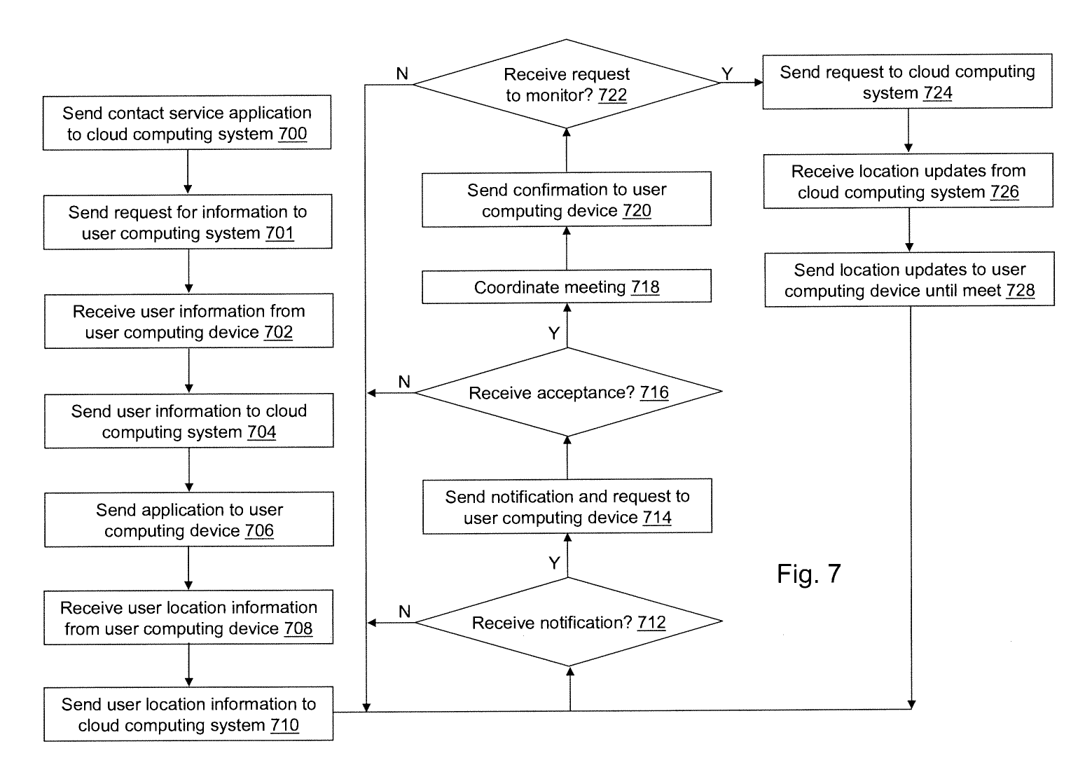

With reference to FIG. 7, illustrative operations performed by middleware system 104 are described. Additional, fewer, or different operations may be performed, depending on the embodiment. The order of presentation of the operations of FIG. 7 is not intended to be limiting. Middleware system 104 defines the parameters for returning readable data to computing device 102 using application programming interfaces, for example associated with operating system compatibility, display capability, media player capability, etc. In an operation 700, the one or more geo-location contact service applications are sent to cloud computing system 106. In an operation 701, a request for information is sent to user computing device 102. In an operation 702, the user information is received from user computing device 102. In an operation 704, the received user information is sent to cloud computing system 106. In an operation 706, geo-location contact service application 210 is sent to user computing device 102.

In an operation 708, user location information is received from user computing device 102. In an operation 710, the received location information is sent to cloud computing system 106. If a notification is not received in an operation 712, processing continues at operation 712 to continuously monitor for a notification from cloud computing system 106. If a notification is received in operation 712, processing continues at operation 714. In operation 714, the received notification is sent to user computing device 102 with a request to confirm whether or not a meeting is desired by the user. If an acceptance is not received in an operation 716, processing continues at operation 712 to continuously monitor for a notification from cloud computing system 106. If an acceptance is received in operation 716, processing continues at an operation 718. In operation 718, a meeting is coordinated by sending the acceptance and a request to meet to the one or more other users that the user has indicated a desire to meet. If any of the one or more other users also accept the request, in an operation 720, a confirmation is sent to user computing device 102.

If a monitor request is not received in an operation 722, processing continues at operation 712 to continuously monitor for a notification from cloud computing system 106. If a monitor request is received in operation 722, processing continues at an operation 724. In operation 724, a request to monitor the location of the meeting attendees is sent to cloud computing system 106. In an operation 726, location updates for the meeting attendees is received from cloud computing system 106. In an operation 728, the received location updates for the meeting attendees are sent to user computing device 102 until the meeting attendees meet. Processing continues at operation 712 to continuously monitor for a notification from cloud computing system 106.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits, Field Programmable Gate Arrays, digital signal processors, or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A device comprising:
a communication interface configured to receive first information from a second device;
a processor; and
a computer-readable medium including computer-readable instructions that, upon execution by the processor, cause the device to
identify contacts using user profile information for a first user, wherein the received first information includes the user profile information;
identify a current geographic location of the identified contacts and the first user based on user location information, wherein the received first information further includes user location information for a plurality of users, wherein the plurality of users includes the identified contacts and the first user;
determine a distance between a contact of the identified contacts and the first user; and
if the determined distance is within a notification distance, create a notification message and send the notification message to the second device, wherein the notification message includes an identifier of the contact and the first user and an indicator of the current geographic location of the contact.

2. The device of claim 1, wherein the computer-readable instructions are further configured to cause the device to send a geographic location update message to the second device, wherein the geographic location update message includes a second geographic location of the contact at a later time.

3. The device of claim 1, wherein the contacts are further identified using a dating service application to identify matches between the plurality of users and the first user.

4. The device of claim 1, wherein the received user profile information includes a contact list and the contacts are identified from the contact list.

5. The device of claim 1, wherein the notification distance is defined by the first user.

6. The device of claim 1, wherein the communication interface is further configured to receive a geo-location contact service application from the second device.

7. The device of claim 6, wherein the processor executes the received geo-location contact service application to identify the contacts, to identify the current geographic location, to determine the distance, and to create the notification message.

8. A computer-readable medium including computer-readable instructions that, upon execution by a processor, cause a device to:
receive user profile information for a first user and user location information for a plurality of users from a second device;
identify contacts using the received user profile information;
identify a current geographic location of the identified contacts and the first user based on the received user location information, wherein the plurality of users includes the identified contacts and the first user;
determine a distance between a contact of the identified contacts and the first user; and
if the determined distance is within a notification distance, create a notification message and send the notification message to the second device, wherein the notification message includes an identifier of the contact and the first user and an indicator of the current geographic location of the contact.

9. The computer-readable medium of claim 8, wherein the computer-readable instructions are further configured to cause the device to send a geographic location update message to the second device, wherein the geographic location update message includes a second geographic location of the contact at a later time.

10. The computer-readable medium of claim 8, wherein the contacts are further identified using a dating service application to identify matches between the plurality of users and the first user.

11. The computer-readable medium of claim 8, wherein the received user profile information includes a contact list and the contacts are identified from the contact list.

12. The computer-readable medium of claim 8, wherein the notification distance is defined by the first user.

13. The computer-readable medium of claim 8, wherein the computer-readable instructions are further configured to cause the device to receive a geo-location contact service application from the second device.

14. A method of providing a notification to a user of a geographic proximity to another user, the method comprising:
receiving user profile information for a first user and user location information for a plurality of users from a second device at a first device;
identifying contacts using the received user profile information;
identifying a current geographic location of the identified contacts and the first user based on the received user location information, wherein the plurality of users includes the identified contacts and the first user;
determining a distance between a contact of the identified contacts and the first user; and
if the determined distance is within a notification distance, creating a notification message and sending the notification message to the second device from the first device, wherein the notification message includes an identifier of the contact and the first user and an indicator of the current geographic location of the contact.

15. The method of claim 14, further comprising sending a geographic location update message to the second device from the first device, wherein the geographic location update message includes a second geographic location of the contact at a later time.

16. The method of claim 14, wherein the contacts are further identified using a dating service application to identify matches between the plurality of users and the first user.

17. The method of claim 14, wherein the received user profile information includes a contact list and the contacts are identified from the contact list.

18. The method of claim 14, wherein the notification distance is defined by the first user.

19. The method of claim 14, further comprising receiving a geo-location contact service application from the second device at the first device.

20. The method of claim 19, further comprising executing the received geo-location contact service application to identify the contacts, to identify the current geographic location, to determine the distance, and to create the notification message.
